(19) United States
(12) Patent Application Publication
(10) Pub. No.: US 2016/0069771 A1
(43) Pub. Date: Mar. 10, 2016

(54) SYSTEM AND METHODS FOR FUEL SYSTEM LEAK DETECTION

(71) Applicant: Ford Global Technologies, LLC, Dearborn, MI (US)

(72) Inventors: Imad Hassan Makki, Dearborn Heights, MI (US); Fling Finn Tseng, Ann Arbor, MI (US); Aed M. Dudar, Canton, MI (US); Robert Roy Jentz, Westland, MI (US); Pankaj Kumar, Dearborn, MI (US)

(21) Appl. No.: 14/482,423

(22) Filed: Sep. 10, 2014

(51) Int. Cl. G01M 3/26

(52) U.S. Cl. CPC G01M 3/26

(57) ABSTRACT

A method for a fuel system comprises indicating a leak in the fuel system based on a pressure change rate distribution during a first condition including a sealed fuel system and a pressure change rate within a threshold of zero. By indicating a leak based on a pressure change rate distribution rather than through simple thresholding, an engine-off natural vacuum test may be performed in a greater range of conditions. In this way, the execution rate of the test may be increased while maintaining or improving the leak detection rate and reducing the misclassification rate.

### BACKGROUND AND SUMMARY

Vehicle emission control systems may be configured to store fuel vapors from fuel tank refueling and diurnal engine operations, and then purge the stored vapors during a subsequent engine operation. In an effort to meet stringent federal emissions regulations, emission control systems may need to be intermittently diagnosed for the presence of leaks that could release fuel vapors to the atmosphere.

Evaporative leaks may be identified using engine-off natural vacuum (EONV) during conditions when a vehicle engine is not operating. In particular, a fuel system may be isolated at an engine-off event. The pressure in such a fuel system will increase if the tank is heated further (e.g. from hot exhaust or a hot parking surface) as liquid fuel vaporizes. As a fuel tank cools down, a vacuum is generated therein as fuel vapors condense to liquid fuel. Vacuum generation is monitored and leaks identified based on expected vacuum development or expected rates of vacuum development.

Federal requirements for leak detection progressively become more stringent. In particular, manufacturers desiring to designate vehicles as practically zero emission vehicles (PZEVs) must prove high levels of performance both for individual vehicles and manufacturing runs of vehicles. Vehicles are required to perform leak tests with a high rate of execution, a low threshold for detection, and a high robustness. Typically, on-board sensors are used to identify situations where leak tests are likely to result in a definitive result (either pass or fail). Relaxing entry conditions to maintain a high rate of execution may reduce the robustness of a test, as EONV tests may have to be performed under less than ideal conditions.

The inventors herein have recognized the above issues and have developed systems and methods to at least partially address them. In one example, a method for a fuel system comprises indicating a leak in the fuel system based on a pressure change rate distribution during a first condition including a sealed fuel system and a pressure change rate within a threshold of zero. By indicating a leak based on a pressure change rate distribution rather than through simple thresholding, an engine-off natural vacuum test may be performed in a greater range of conditions. In this way, the execution rate of the test may be increased while maintaining or improving the leak detection rate and reducing the misclassification rate.

In another example, a method for a fuel system comprises sealing a fuel system; and executing an evaporative emissions leak test only if a duration of a fuel system pressure increase event is greater than a threshold. By evaluating the initial fuel system pressure increase event, the misclassification rate of an engine-off natural vacuum test may be reduced, thereby increasing the robustness of the test. In this way, false results can be avoided, saving unnecessary warranty inspections and reducing overall costs for the vehicle manufacturer.

In yet another example, a fuel system for a vehicle, comprising a fuel tank coupled to an evaporative emissions system; a valve coupled between the fuel tank and atmosphere; a pressure sensor coupled between the fuel tank and the valve; and a controller holding executable instructions in non-transitory memory, that when executed, cause the controller to: close the valve; execute an evaporative emissions leak test responsive to a duration of a fuel system pressure increase event being greater than a threshold; determine a minimum error between an equilibrium fuel tank pressure and a predicted fuel tank pressure; determine a pressure change rate distribution within the fuel system during a condition where a pressure change rate is within a threshold of zero; using a linear classifier, indicate a fuel system leak based on the determined minimum error and the determined pressure change rate distribution; and indicate an indeterminate result if an output of the linear classifier is within a threshold of a decision boundary. By extracting fuel system features for classification by a linear classifier, the EONV test may provide enough extractable features to classify a fuel system as intact or leaky without running the test to a vacuum threshold endpoint. This, in turn may reduce the amount of battery power used in performing the test.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTIONS OF THE DRAWINGS

FIG. 1 schematically shows a fuel system and an emissions system for an example vehicle engine.

FIG. 2 shows a flow-chart for a high-level method for an engine-off natural vacuum test.

FIG. 3A shows a flow-chart for a high-level method for comparing observed vapor pressure to expected vapor pressure.

FIG. 3B shows an example plot of pressure/temperature relationships for two different fuel compositions.

FIG. 3C shows a timeline for an example engine-off natural vacuum test.

FIG. 4 shows a flow-chart for a high-level method for determining pressure change rate distribution content for a sealed system.

FIG. 5 shows an example plot of classified data sets representative of intact fuel systems and leaky fuel systems.

### DETAILED DESCRIPTION

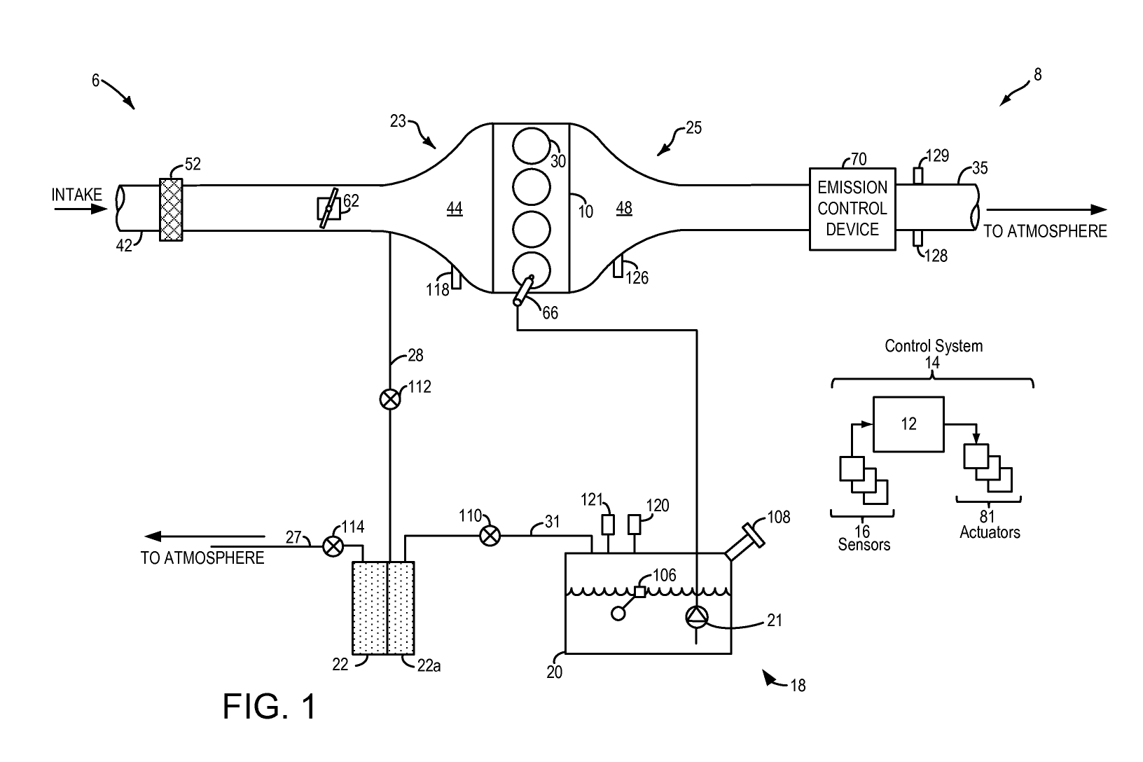

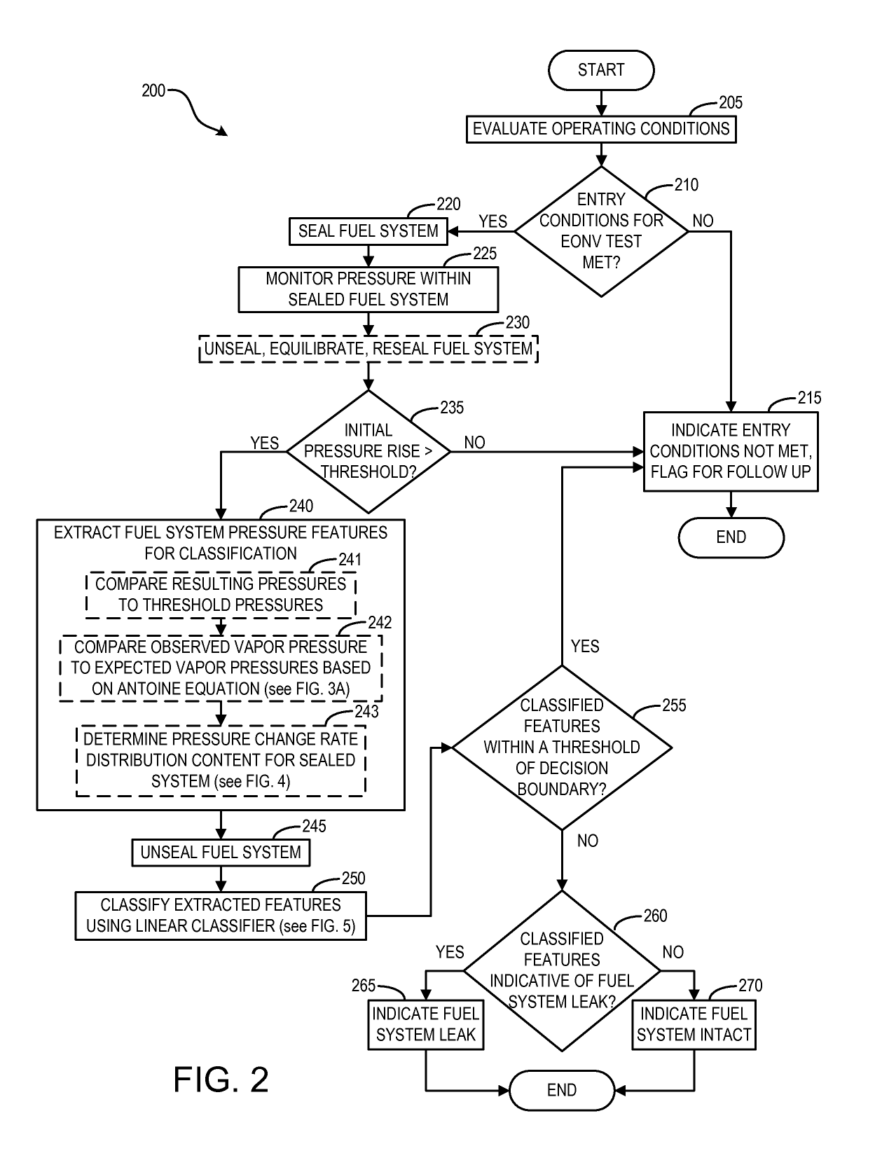

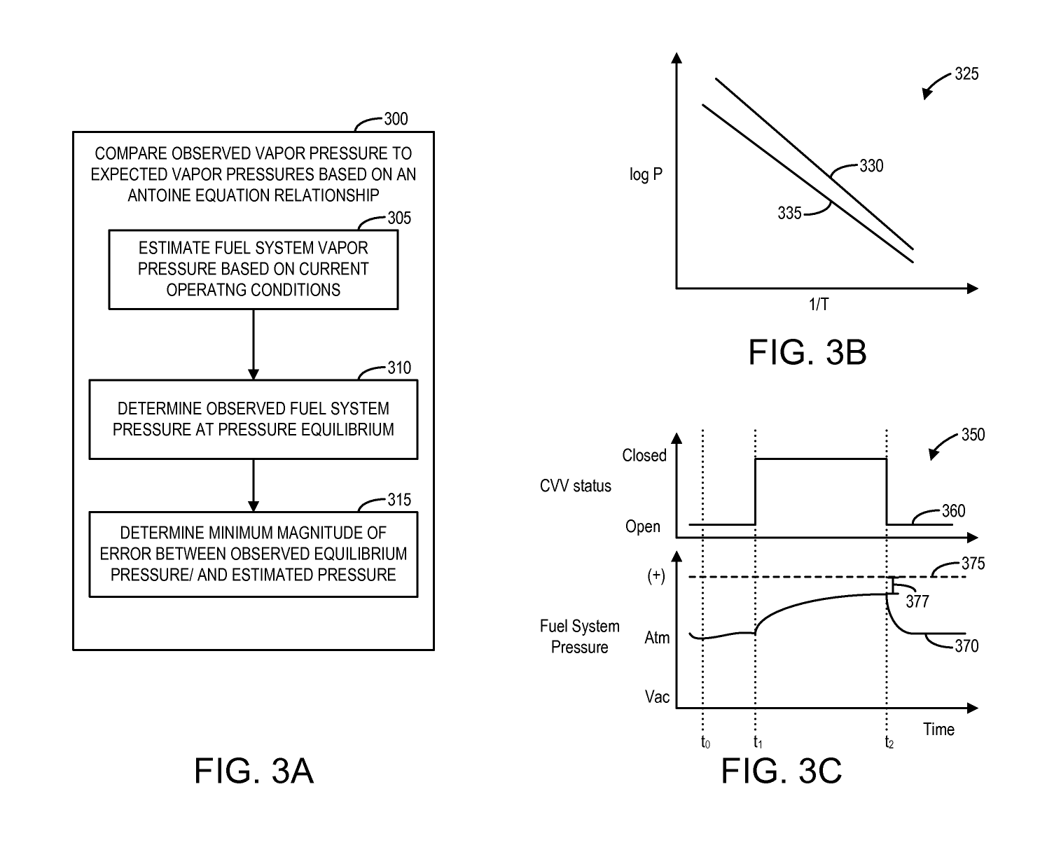

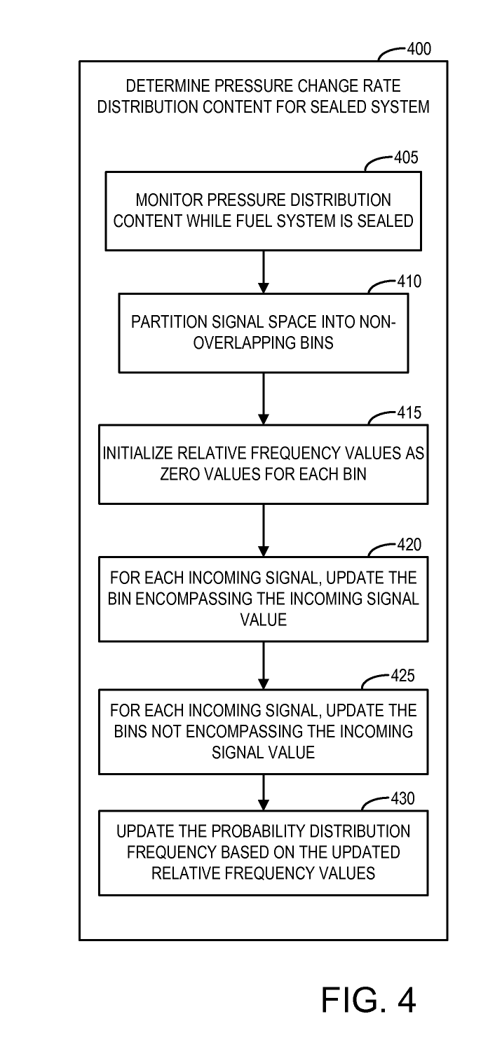

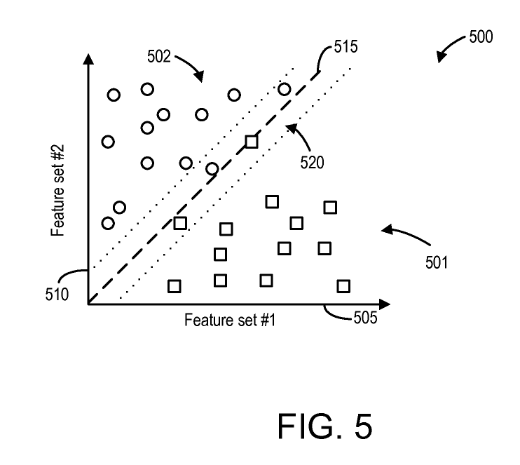

This detailed description relates to systems and methods for a vehicle fuel system. More specifically, the description relates to systems and methods for performing engine-off natural vacuum tests on a fuel system for the purpose of detecting leaks. The fuel system may be included in a hybrid vehicle system, as shown schematically in FIG. 1. FIG. 2 shows an example method for an EONV test, including the extraction of fuel system pressure features that may be classified in order to determine whether the fuel system is leaky or intact. One example fuel system pressure feature is a comparison of observed vapor pressure and expected vapor pressure based on the Antoine equation. An example method thereof is shown in FIG. 3A. FIG. 3B shows an example plot of pressure/temperature relationships for two different fuel compositions, the pressure/temperature relationships transformed by the Antoine equation. An example timeline for an EONV test including this comparison is shown in FIG. 3C. Another example fuel system pressure feature includes determining pressure change rate distribution content for a sealed fuel system, as shown in FIG. 4A. The extracted features may be classified using a linear classifier. The linear classifier may classify data sets within a threshold of a decision boundary as indeterminate, as shown in FIG. 5.

FIG. 1 shows a schematic depiction of a hybrid vehicle system 6 that can derive propulsion power from engine system 8 and/or an on-board energy storage device, such as a battery system (not shown). An energy conversion device, such as a generator (not shown), may be operated to absorb energy from vehicle motion and/or engine operation, and then convert the absorbed energy to an energy form suitable for storage by the energy storage device.

Engine system 8 may include an engine 10 having a plurality of cylinders 30. Engine 10 includes an engine intake 23 and an engine exhaust 25. Engine intake 23 includes an air intake throttle 62 fluidly coupled to the engine intake manifold 44 via an intake passage 42. Air may enter intake passage 42 via air filter 52. Engine exhaust 25 includes an exhaust manifold 48 leading to an exhaust passage 35 that routes exhaust gas to the atmosphere. Engine exhaust 25 may include one or more emission control devices 70 mounted in a close-coupled position. The one or more emission control devices may include a three-way catalyst, lean NOx trap, diesel particulate filter, oxidation catalyst, etc. It will be appreciated that other components may be included in the engine such as a variety of valves and sensors, as further elaborated in herein. In some embodiments, wherein engine system 8 is a boosted engine system, the engine system may further include a boosting device, such as a turbocharger (not shown).

Engine system 8 is coupled to a fuel system 18. Fuel system 18 includes a fuel tank 20 coupled to a fuel pump 21 and a fuel vapor canister 22. During a fuel tank refueling event, fuel may be pumped into the vehicle from an external source through refueling port 108. Fuel tank 20 may hold a plurality of fuel blends, including fuel with a range of alcohol concentrations, such as various gasoline-ethanol blends, including E10, E85, gasoline, etc., and combinations thereof. A fuel level sensor 106 located in fuel tank 20 may provide an indication of the fuel level (“Fuel Level Input”) to controller 12. As depicted, fuel level sensor 106 may comprise a float connected to a variable resistor. Alternatively, other types of fuel level sensors may be used.

Fuel pump 21 is configured to pressurize fuel delivered to the injectors of engine 10, such as example injector 66. While only a single injector 66 is shown, additional injectors are provided for each cylinder. It will be appreciated that fuel system 18 may be a return-less fuel system, a return fuel system, or various other types of fuel system. Vapors generated in fuel tank 20 may be routed to fuel vapor canister 22, via conduit 31, before being purged to the engine intake 23.

Fuel vapor canister 22 is filled with an appropriate adsorbent for temporarily trapping fuel vapors (including vaporized hydrocarbons) generated during fuel tank refueling operations, as well as diurnal vapors. In one example, the adsorbent used is activated charcoal. When purging conditions are met, such as when the canister is saturated, vapors stored in fuel vapor canister 22 may be purged to engine intake 23 by opening canister purge valve 112. While a single canister 22 is shown, it will be appreciated that fuel system 18 may include any number of canisters. In one example, canister purge valve 112 may be a solenoid valve wherein opening or closing of the valve is performed via actuation of a canister purge solenoid.

Canister 22 may include a buffer 22a (or buffer region), each of the canister and the buffer comprising the adsorbent. As shown, the volume of buffer 22a may be smaller than (e.g., a fraction of) the volume of canister 22. The adsorbent in the buffer 22a may be same as, or different from, the adsorbent in the canister (e.g., both may include charcoal). Buffer 22a may be positioned within canister 22 such that during canister loading, fuel tank vapors are first adsorbed within the buffer, and then when the buffer is saturated, further fuel tank vapors are adsorbed in the canister. In comparison, during canister purging, fuel vapors are first desorbed from the canister (e.g., to a threshold amount) before being desorbed from the buffer. In other words, loading and unloading of the buffer is not linear with the loading and unloading of the canister. As such, the effect of the canister buffer is to dampen any fuel vapor spikes flowing from the fuel tank to the canister, thereby reducing the possibility of any fuel vapor spikes going to the engine.

Canister 22 includes a vent 27 for routing gases out of the canister 22 to the atmosphere when storing, or trapping, fuel vapors from fuel tank 20. Vent 27 may also allow fresh air to be drawn into fuel vapor canister 22 when purging stored fuel vapors to engine intake 23 via purge line 28 and purge valve 112. While this example shows vent 27 communicating with fresh, unheated air, various modifications may also be used. Vent 27 may include a canister vent valve 114 to adjust a flow of air and vapors between canister 22 and the atmosphere. The canister vent valve may also be used for diagnostic routines. When included, the vent valve may be opened during fuel vapor storing operations (for example, during fuel tank refueling and while the engine is not running) so that air, stripped of fuel vapor after having passed through the canister, can be pushed out to the atmosphere. Likewise, during purging operations (for example, during canister regeneration and while the engine is running), the vent valve may be opened to allow a flow of fresh air to strip the fuel vapors stored in the canister. In one example, canister vent valve 114 may be a solenoid valve wherein opening or closing of the valve is performed via actuation of a canister vent solenoid. In particular, the canister vent valve may be an open that is closed upon actuation of the canister vent solenoid. In some examples, an air filter may be coupled in vent 27 between canister vent valve 114 and atmosphere.

As such, hybrid vehicle system 6 may have reduced engine operation times due to the vehicle being powered by engine system 8 during some conditions, and by the energy storage device under other conditions. While the reduced engine operation times reduce overall carbon emissions from the vehicle, they may also lead to insufficient purging of fuel vapors from the vehicle's emission control system. To address this, a fuel tank isolation valve 110 may be optionally included in conduit 31 such that fuel tank 20 is coupled to canister 22 via the valve. During regular engine operation, isolation valve 110 may be kept closed to limit the amount of diurnal or “running loss” vapors directed to canister 22 from fuel tank 20. During refueling operations, and selected purging conditions, isolation valve 110 may be temporarily opened, e.g., for a duration, to direct fuel vapors from the fuel tank 20 to canister 22. By opening the valve during purging conditions when the fuel tank pressure is higher than a threshold (e.g., above a mechanical pressure limit of the fuel tank above which the fuel tank and other fuel system components may incur mechanical damage), the refueling vapors may be released into the canister and the fuel tank pressure may be maintained below pressure limits. While the depicted example shows isolation valve 110 positioned along conduit 31, in alternate embodiments, the isolation valve may be mounted on fuel tank 20. The fuel system may be considered to be sealed when isolation valve 110 is closed. In embodiments where the fuel system does not include isolation valve 110, the fuel system may be considered sealed when purge valve 112 and canister vent valve 114 are both closed.

One or more pressure sensors 120 may be coupled to fuel system 18 for providing an estimate of a fuel system pressure. In one example, the fuel system pressure is a fuel tank pressure, wherein pressure sensor 120 is a fuel tank pressure sensor coupled to fuel tank 20 for estimating a fuel tank pressure or vacuum level. While the depicted example shows pressure sensor 120 directly coupled to fuel tank 20, in alternate embodiments, the pressure sensor may be coupled between the fuel tank and canister 22, specifically between the fuel tank and isolation valve 110. In still other embodiments, a first pressure sensor may be positioned upstream of the isolation valve (between the isolation valve and the canister) while a second pressure sensor is positioned downstream of the isolation valve (between the isolation valve and the fuel tank), to provide an estimate of a pressure difference across the valve. In some examples, a vehicle control system may infer and indicate a fuel system leak based on changes in a fuel tank pressure during a leak diagnostic routine.

One or more temperature sensors 121 may also be coupled to fuel system 18 for providing an estimate of a fuel system temperature. In one example, the fuel system temperature is a fuel tank temperature, wherein temperature sensor 121 is a fuel tank temperature sensor coupled to fuel tank 20 for estimating a fuel tank temperature. While the depicted example shows temperature sensor 121 directly coupled to fuel tank 20, in alternate embodiments, the temperature sensor may be coupled between the fuel tank and canister 22.

Fuel vapors released from canister 22, for example during a purging operation, may be directed into engine intake manifold 44 via purge line 28. The flow of vapors along purge line 28 may be regulated by canister purge valve 112, coupled between the fuel vapor canister and the engine intake. The quantity and rate of vapors released by the canister purge valve may be determined by the duty cycle of an associated canister purge valve solenoid (not shown). As such, the duty cycle of the canister purge valve solenoid may be determined by the vehicle's powertrain control module (PCM), such as controller 12, responsive to engine operating conditions, including, for example, engine speed-load conditions, an air-fuel ratio, a canister load, etc. By commanding the canister purge valve to be closed, the controller may seal the fuel vapor recovery system from the engine intake. An optional canister check valve (not shown) may be included in purge line 28 to prevent intake manifold pressure from flowing gases in the opposite direction of the purge flow. As such, the check valve may be necessary if the canister purge valve control is not accurately timed or the canister purge valve itself can be forced open by a high intake manifold pressure. An estimate of the manifold absolute pressure (MAP) or manifold vacuum (ManVac) may be obtained from MAP sensor 118 coupled to intake manifold 44, and communicated with controller 12. Alternatively, MAP may be inferred from alternate engine operating conditions, such as mass air flow (MAF), as measured by a MAF sensor (not shown) coupled to the intake manifold.

Fuel system 18 may be operated by controller 12 in a plurality of modes by selective adjustment of the various valves and solenoids. For example, the fuel system may be operated in a fuel vapor storage mode (e.g., during a fuel tank refueling operation and with the engine not running), wherein the controller 12 may open isolation valve 110 and canister vent valve 114 while closing canister purge valve (CPV) 112 to direct refueling vapors into canister 22 while preventing fuel vapors from being directed into the intake manifold.

As another example, the fuel system may be operated in a refueling mode (e.g., when fuel tank refueling is requested by a vehicle operator), wherein the controller 12 may open isolation valve 110 and canister vent valve 114, while maintaining canister purge valve 112 closed, to depressurize the fuel tank before allowing enabling fuel to be added therein. As such, isolation valve 110 may be kept open during the refueling operation to allow refueling vapors to be stored in the canister. After refueling is completed, the isolation valve may be closed.

As yet another example, the fuel system may be operated in a canister purging mode (e.g., after an emission control device light-off temperature has been attained and with the engine running), wherein the controller 12 may open canister purge valve 112 and canister vent valve while closing isolation valve 110. Herein, the vacuum generated by the intake manifold of the operating engine may be used to draw fresh air through vent 27 and through fuel vapor canister 22 to purge the stored fuel vapors into intake manifold 44. In this mode, the purged fuel vapors from the canister are combusted in the engine. The purging may be continued until the stored fuel vapor amount in the canister is below a threshold. During purging, the learned vapor amount/concentration can be used to determine the amount of fuel vapors stored in the canister, and then during a later portion of the purging operation (when the canister is sufficiently purged or empty), the learned vapor amount/concentration can be used to estimate a loading state of the fuel vapor canister.

Vehicle system 6 may further include control system 14. Control system 14 is shown receiving information from a plurality of sensors 16 (various examples of which are described herein) and sending control signals to a plurality of actuators 81 (various examples of which are described herein). As one example, sensors 16 may include exhaust gas sensor 126 located upstream of the emission control device, temperature sensor 128, MAP sensor 118, pressure sensor 120, and pressure sensor 129. Other sensors such as additional pressure, temperature, air/fuel ratio, and composition sensors may be coupled to various locations in the vehicle system 6. For example, ambient temperature and pressure sensors may be coupled to the exterior of the vehicle body. As another example, the actuators may include fuel injector 66, isolation valve 110, purge valve 112, vent valve 114, fuel pump 21, and throttle 62.

Control system 14 may further receive information regarding the location of the vehicle from an on-board global positioning system (GPS). Information received from the GPS may include vehicle speed, vehicle altitude, vehicle position, etc. This information may be used to infer engine operating parameters, such as local barometric pressure. Control system 14 may further be configured to receive information via the internet or other communication networks. Information received from the GPS may be cross-referenced to information available via the internet to determine local weather conditions, local vehicle regulations, etc. Control system 14 may use the internet to obtain updated software modules which may be stored in non-transitory memory.

The control system 14 may include a controller 12. Controller 12 may be configured as a conventional microcomputer including a microprocessor unit, input/output ports, read-only memory, random access memory, keep alive memory, a controller area network (CAN) bus, etc. Controller 12 may be configured as a powertrain control module (PCM). The controller may be shifted between sleep and wake-up modes for additional energy efficiency. The controller may receive input data from the various sensors, process the input data, and trigger the actuators in response to the processed input data based on instruction or code programmed therein corresponding to one or more routines. Example control routines are described herein with regard to FIGS. 2, 3A, and 4.

Controller 12 may also be configured to intermittently perform leak detection routines on fuel system 18 (e.g., fuel vapor recovery system) to confirm that the fuel system is not degraded. As such, various diagnostic leak detection tests may be performed while the engine is off (engine-off leak test) or while the engine is running (engine-on leak test). Leak tests performed while the engine is running may include applying a negative pressure on the fuel system for a duration (e.g., until a target fuel tank vacuum is reached) and then sealing the fuel system while monitoring a change in fuel tank pressure (e.g., a rate of change in the vacuum level, or a final pressure value). Leak tests performed while the engine is not running may include sealing the fuel system following engine shut-off and monitoring a change in fuel tank pressure. This type of leak test is referred to herein as an engine-off natural vacuum test (EONV). In sealing the fuel system following engine shut-off, a vacuum will develop in the fuel tank as the tank cools and fuel vapors are condensed to liquid fuel. The amount of vacuum and/or the rate of vacuum development may be compared to expected values that would occur for a system with no leaks, and/or for a system with leaks of a predetermined size. Following a vehicle-off event, as heat continues to be rejected from the engine into the fuel tank, the fuel tank pressure will initially rise. During conditions of relatively high ambient temperature, a pressure build above a threshold may be considered a passing test.

Federal requirements for leak detection progressively become more stringent. In particular, manufacturers desiring to designate vehicles as practically zero emission vehicles (PZEVs) must prove high levels of performance both for individual vehicles and manufacturing runs of vehicles. Vehicles are required to perform leak tests with a high rate of execution, with a low threshold for detection, and with a high robustness. Typically, on-board sensors are used to identify situations where leak tests are likely to result in a definitive result (either pass or fail). Relaxing entry conditions to maintain a high rate of execution may reduce the robustness of a test, as EONV tests may have to be performed under less than ideal conditions.

FIG. 2 shows a flow chart for an example high-level method 200 for an engine-off natural vacuum test for a vehicle fuel system. Method 200 will be described in relation to the hybrid vehicle system depicted in FIG. 1, but it should be understood that similar methods may be used with other systems without departing from the scope of this disclosure. Method 200 may be carried out by a controller, such as controller 12, and may be stored as executable instructions in non-transitory memory.

Method 200 begins at 205. At 205, method 200 includes evaluating operating conditions. Operating conditions may be measured, estimated, or inferred. Among other conditions, operating conditions may include various vehicle conditions, such as vehicle speed, vehicle location, etc., various engine conditions, such as engine status, engine load, engine temperature, etc., various fuel system conditions, such as fuel tank pressure, fuel tank temperature, fuel fill level, fuel vapor canister level, etc., and various ambient conditions, such as ambient temperature, humidity, barometric pressure, etc.

Continuing at 210, method 200 includes determining whether entry conditions are met for an EONV test. For an engine-off natural vacuum test, the engine must be at rest with all cylinders off. In some examples, the vehicle must be shut off completely. Entry conditions may include an indication to perform an EONV test based on a number of driving trips since the most recent EONV test. Additional entry conditions may include a threshold amount of time passed since the previous EONV test, a threshold length of engine run time prior to the engine-off event, a threshold air mass passing through an engine intake during the engine run time prior to the engine-off event, a threshold amount of fuel in the fuel tank, a threshold ambient barometric pressure, an ambient temperature within a range of ambient temperatures, and a threshold battery state of charge. If entry conditions are not met, method 200 may proceed to 215. At 215, method 200 may include recording that an EONV test was not executed, and may further include setting a flag to retry the EONV test at the next detected vehicle-off event. Method 200 may then end.

Although entry conditions may be met initially during the execution of method 200, systemic and ambient conditions may change during the execution of the method. For example, an engine restart or refueling event may be sufficient to abort the method at any point prior to completing method 200. If such events are detected that would interfere with the execution of method 200 or the interpretation of results derived from executing method 200, method 200 may proceed to 215, record that an EONV test was not executed, set a flag to retry the EONV test at the next detected vehicle-off event, and then end.

If entry conditions for an EONV test are met, method 200 may proceed to 220. At 220, method 200 may include sealing the vehicle fuel system from atmosphere. For the hybrid vehicle system depicted in FIG. 1, this may include closing (or maintaining closed) CPV 112, and may further include closing CVV 114. Additionally or alternatively, in some examples, FTIV 110 may be closed. Continuing at 225, method 200 may include monitoring pressure within the sealed fuel system. Fuel system pressure may be inferred or measured, for example using fuel tank pressure sensor 120.

Continuing at 230, method 200 may optionally include unsealing the fuel system, allowing the fuel system pressure to equilibrate, and then re-sealing the fuel system. For example, following the initial sealing of the fuel system, the fuel system pressure may increase as heat is rejected to the fuel tank from the engine. In some examples, the fuel tank may be initially sealed for a duration, and then unsealed if the fuel system pressure fails to reach a threshold pressure by the end of the duration. The fuel system may then be allowed to equilibrate to atmospheric pressure, and resealed to allow a vacuum to develop in the fuel system as the fuel tank continues to cool. In some examples, the fuel system may be unsealed upon the fuel system pressure reaching a threshold, then resealed to allow for a second pressure-rise event to occur. However, in some examples, upon the fuel system reaching a threshold pressure following the first system sealing, the fuel system may be unsealed, but not resealed. During time periods where the fuel system is sealed, the pressure may be monitored as described above. Pressure may also be monitored during time periods where the fuel system is unsealed, but this data may not contribute to the determination of fuel system integrity.

At 235, method 200 may include determining whether the fuel system pressure rise upon initially sealing the fuel system is greater than a threshold. The threshold may be predetermined or may be based on current operating conditions. The initial pressure rise may be characterized as a change in pressure over a predetermined duration, and/or as an amount of time the fuel system takes to reach a threshold pressure. For example, a duration of a fuel system pressure increase event may be monitored to determine whether the duration is greater than a threshold. Failure to meet the threshold pressure change may indicate a gross leak, or may indicate that conditions are not met for performing a conclusive EONV test. For example, the fuel system pressure may not initially increase if a gas cap is unsealed, or if ambient temperature is similar to fuel system temperature. If the initial pressure rise is less than the threshold, method 200 may proceed to 215. At 215, method 200 may include recording that an EONV test was not executed, and may further include setting a flag to retry the EONV test at the next detected vehicle-off event. Method 200 may then end.

If the initial pressure rise is greater than the threshold, method 200 may proceed to 240. At 240, method 200 may include extracting fuel system pressure features for classification. The fuel system pressure features may be derived from the monitored pressure within the sealed fuel system as described herein, and may be based on absolute pressure values and/or rates of change of pressure values over time. The pressure features may be further based on systemic or ambient conditions. One or more fuel system pressure features may be extracted. Herein, three fuel system pressure features are described, but other fuel system pressure features may be derived in addition to or as an alternative to the features described.

For example, at 241, method 200 may include comparing one or more resulting fuel system pressures to one or more threshold pressures. For example, method 200 may include a pressure rise test portion where an initial fuel tank pressure increase is compared to a threshold pressure, and/or a vacuum test portion where a fuel tank vacuum is compared to a threshold vacuum. While the engine is still cooling down post shut-down, there may be additional heat rejected to the fuel tank. With the fuel system sealed via the closing of the CVV, the pressure in the fuel system may rise due to fuel volatizing with increased temperature. The pressure rise test portion may include monitoring fuel tank pressure for a period of time. Fuel tank pressure may be monitored until the pressure reaches a threshold pressure, the threshold pressure indicative of no leaks above a threshold size in the fuel system. In some examples, the rate of pressure change may be compared to an expected rate of pressure change.

As described above, following the initial pressure rise, the fuel system may be unsealed, allowed to equilibrate, and resealed. As the fuel tank cools, the fuel vapors condense into liquid fuel, creating a vacuum within the sealed tank. Fuel tank pressure may be monitored until the vacuum reaches a predetermined threshold vacuum, the predetermined threshold vacuum indicative of no leaks above a threshold size in the fuel tank. In some examples, the rate of pressure change may be compared to an expected rate of pressure change. The threshold pressure(s) and vacuum(s) may be based on system and ambient conditions, such as fuel level, engine temperature, ambient temperature, ambient barometric pressure, etc.

The reaching of one or more thresholds during the EONV test may be indicative of an intact fuel system. Not reaching a threshold during the EONV test may be indicative of a leak in a fuel system. However, based on operating conditions, not reaching a threshold during the EONV test may be considered an inconclusive result. The comparison(s) of resulting pressures to threshold pressures may be extracted and stored as fuel system pressure features at controller 12.

Continuing at 242, method 200 may include comparing an observed fuel system vapor pressure to an expected fuel system vapor pressure based on an Antoine equation relationship. The Antoine equation describes the relationship between pressure and temperature of a vapor in a sealed setting. A linear relationship between pressure and temperature may be derived when pressure is transformed via a log operation and temperature is transformed via an inverse operation. A flow-chart for an example high-level method 300 for comparing observed vapor pressure to expected vapor pressure based on an Antoine equation relationship is shown in FIG. 3A. Method 300 may be carried out by a controller, such as controller 12, and may be stored as executable instructions in non-transitory memory.

Method 300 may begin at 305. At 305, method 300 may include estimating fuel system vapor pressure based on current operating conditions. Using the Antoine equation, a linear relationship may be described between vapor pressure and temperature. In general, the Antoine equation may be expressed as:

log P=A−(B/(C+T))

Where P is pressure, T is temperature (in degrees Fahrenheit) and A, B, and C are fuel composition specific coefficients. The fuel composition specific coefficients may be based on the properties of a fuel stored in the fuel tank. Temperature may be inferred or measured, such as by fuel tank temperature sensor 121. FIG. 3B shows an example plot 325 showing the linear relationship between log P and 1/T for two different fuel compositions. Line 330 represents a pressure/temperature relationship for E100 (100% ethanol), while line 335 represents a pressure/temperature relationship for E0 (100% petrol). Other blends of ethanol/petrol, such as E10, E15, E85, etc. may have relationships with slopes falling between the slopes of line 330 and line 335. Similar relationships may be derived for other fuels, such as diesel fuel, liquid natural gas (LNG), etc. An estimated pressure based on temperature and fuel composition may be further based on fuel fill level, fuel tank configuration, etc. The estimated pressure may be considered the pressure at equilibrium.

Continuing at 310, method 300 may include determining the observed fuel system pressure at pressure equilibrium. For example, following sealing of the fuel system (e.g., closing of the CVV) the fuel system pressure may be monitored until the pressure reaches equilibrium. For example, the fuel system pressure may be measured at regular intervals, until two or more consecutive measurements are within a threshold of each other. Continuing at 315, method 300 may include determining a minimum magnitude of error between the observed equilibrium pressure and the estimated pressure of the fuel system. The minimum error may then be extracted as a feature for classification.

For example, FIG. 3C shows an example timeline 350 for an EONV test wherein a minimum magnitude of error between an observed equilibrium pressure and an estimated pressure of the fuel system. Timeline 350 includes plot 360, indicating a status of a canister vent valve (CVV) over time. Timeline 350 further includes plot 370, indicating a fuel system pressure over time. Line 375 represents an estimated fuel system pressure based on a fuel system temperature utilizing the Antoine equation.

At time t₀, a vehicle shut-off event occurs (not shown). The CVV is open, as indicated by plot 360, and the fuel system pressure is relatively equivalent to atmospheric pressure, as indicated by plot 370. At time t₁, conditions for the EONV test are met, and the CVV is closed. The fuel system pressure increases from time t₁ to time t₂, as heat is rejected into the fuel system from the engine. At time t₂, the fuel system pressure reaches equilibrium. The magnitude of the difference between the equilibrium pressure and the estimated fuel system pressure is shown at 377. The magnitude of the difference may then be extracted and used for classification. With the fuel system pressure reaching equilibrium at time t₂, the CVV is opened, and the fuel system pressure returns to atmospheric pressure.

Returning to FIG. 2, at 243, method 200 may include determining pressure change rate distribution content for the sealed fuel system. As the fuel system pressure reaches equilibrium, the pressure change rate approaches 0 (ΔP=0). From the pressure change rates, a probability distribution curve may be extracted. For an intact fuel system, the distribution content approaching ΔP=0 is stable (low standard deviation). However, for a leaky fuel system, the distribution content is unstable (high standard deviation). The distribution content of the pressure change rate may be extracted for classification. In some examples, the distribution content may be continuously extracted using a low-pass filter without requiring buffering of the pressure data.

FIG. 4 shows an example method 400 for determining pressure change rate distribution content for a sealed fuel system. Method 400 may be carried out by a controller, such as controller 12, and may be stored as executable instructions in non-transitory memory.

Method 400 may begin at 405. At 405, method 400 may include monitoring pressure distribution content while the fuel system is sealed. A rate of change of fuel system pressure may be extracted based on the fuel system pressure date over time. In particular, as the pressure change rate approaches 0, the pressure distribution content may be monitored and extracted by controller 12. Rates of change may be monitored and recorded periodically. Change rates may be determined for discrete periods of time (e.g. every 1 second) and may be determined for overlapping time frames (e.g. a 1 second window beginning every 0.1 seconds).

Continuing at 410, method 400 may include partitioning a signal space into non-overlapping bins. For example, for a range of pressure change rates, a series of non-overlapping bins may be portioned. The non-overlapping bins may encompass a same range of pressure change rate values (e.g. 0-1, 1-2, 2-3) a log range of pressure change values (e.g. 1-10, 11-100, 1001-1000), or any other suitable means of distributing incoming data. Continuing at 415, method 400 may include initializing relative frequency values (RFV) as zero for each non-overlapping bin.

Continuing at 420, method 400 may include, for each incoming signal (pressure change rate), updating the bin encompassing the incoming signal value. For example, the frequency X(i) for a bin may be updated to equal (1−α)*X(i)+α*1; where a defines a learning rate of constructing a probability distribution frequency, such that captured content is effectively given a moving window size of 1/α. Continuing at 425, method 400 may include, for each incoming signal (pressure change rate), updating the bins not encompassing the incoming signal value. For example, the frequency X(i) for a bin may be updated to equal (1−α)*X(i)+α*0.

Continuing at 430, method 400 may include updating a probability distribution frequency vector based on the updated relative frequency values. For example, the vector PDF may be set equal to RFV/Σ(RFV). In this way, when a probability density frequency is extracted, the RFV vector can be normalized as the sum of its elements, yielding a probability density frequency vector with a magnitude of 1.

Using a low pass filter method of extracting probability distribution frequency allows for a computationally efficient means of extracting a feature which does not require buffering of previously collected data. In this way, the distribution content is always available as a classifiable feature for determining the status of the fuel system. Further, the learning rate may be calibrated and updated for the specific system wherein this method is implemented.

Returning to FIG. 2, at 245, method 200 may include unsealing the fuel system. The fuel system may be unsealed when a predetermined number of fuel system pressure features have been extracted. Unsealing the fuel system may include opening the canister vent valve while maintaining the CPV and FTIV (where included) closed. In this way, the fuel system pressure may be equilibrated to atmospheric pressure.

Continuing at 250, method 200 may include classifying the extracted features using a linear classifier. For example, a support vector machine (SVM) or tool such as Fisher's Linear Discriminant (FLD) may be utilized to classify the extracted features. In this way, rather than simple thresholding of test results, multiple features, such as those described herein may collectively indicate whether a fuel system is intact or leaking. In some examples, an individual feature may have a large overlap between categories (e.g. similar results for intact and leaking systems). By combining multiple features, the class margins may be maximized while model complexity is reduced.

An example plot 500 of classified data sets representative of intact fuel systems and leaky fuel systems is shown in FIG. 5. Plot 500 shows example classified data sets from intact fuel systems (502, circles) and leaky fuel systems (503, squares). For simplicity, the classified data sets are shown based on two feature sets: feature set #1, shown along axis 505 and feature set #2, shown along axis 510. In some embodiments, more feature sets may be used, and/or multiple feature sets may be dimensionally reduced into a single feature set.

Plot 500 includes decision boundary 515. In this example, classified data sets falling between decision boundary 515 and axis 505 are considered indicative of leaky fuel systems, while classified data sets falling between decision boundary 515 and axis 510 are considered indicative of intact fuel systems. Plot 500 further includes buffer region 520. Buffer region 520 includes values within a threshold of decision boundary 515 (both towards axis 505 and towards axis 510). In some embodiments, classified data sets falling within buffer region 520 may be considered indeterminate.

Returning to FIG. 2, at 255, method 200 may include determining whether the classified features are within a threshold of a decision boundary. As shown in FIG. 5, a value within buffer region 520 may be indeterminate as to whether the fuel system pressure characteristics derived during the EONV test are representative of an intact fuel system or a fuel system with a leak greater than a threshold. If the classified features are within a threshold of the decision boundary, method 200 may proceed to 215. At 215, method 200 may include recording that an EONV test was not executed, and may further include setting a flag to retry the EONV test at the next detected vehicle-off event. Method 200 may then end.

If the classified features are not within a threshold of the decision boundary, method 200 may proceed to 260. At 260, method 200 may include determining whether the classified features are indicative of a fuel system leak. For example, as shown in FIG. 5, classified features above the decision boundary are indicative of an intact fuel system, while classified features below the decision boundary are indicative of a fuel system leak. If the classified features are indicative of a fuel system leak, method 200 may proceed to 265. At 265, method 200 may include indicating a fuel system leak. For example, a diagnostic code may be set at controller 12. Method 200 may then end. If the classified features are not indicative of a fuel system leak, method 200 may proceed to 270. At 270, method 200 may include indicating the fuel system is intact. For example, a passing test result may be recorded at controller 12. A flag for follow up may not be set. Method 200 may then end.

Extracting a plurality of features during an EONV test and then classifying those features as indicative of an intact or leaky fuel system may increase the accuracy and robustness of leak detection. Further, entry conditions for EONV tests may be relaxed. For example, entry conditions for barometric pressure, fuel fill level, ambient temperature, and intake air mass may be relaxed or eliminated. In this way, the initiation rate for the EONV test may be increased. As described with regard to FIG. 2, initial pressure rise and results within a threshold of a decision boundary may effectively be used as entry conditions. This approach may increase the execution rate of the EONV test while maintaining or improving the leak detection rate and reducing the misclassification rate. Further, the total execution time may be reduced, as the initial pressure rise portion of the EONV test may provide enough extractable features to classify a fuel system as intact or leaky. This, in turn may reduce the amount of battery power used in performing the test.

The systems described herein and depicted in FIG. 1 along with the methods described herein and depicted in FIGS. 2, 3A, and 4A may enable one or more systems and one or more methods. In one example, a method for a fuel system comprises indicating a leak in the fuel system based on a pressure change rate distribution during a first condition including a sealed fuel system and a pressure change rate within a threshold of zero. The method may further comprise applying a low-pass filter to the pressure change rate distribution; and then indicating the leak in the fuel system based on the filtered pressure change rate distribution. In some examples, the method may further comprise indicating the leak in the fuel system based on a minimum error between a measured fuel tank pressure and a predicted fuel tank pressure. The measured fuel tank pressure may comprise an equilibrium fuel tank pressure. The predicted fuel tank pressure may be based on a fuel tank temperature. The predicted fuel tank pressure may be based on a fuel composition. The predicted fuel tank pressure may be determined using an Antoine equation relationship. In some examples, the method may further comprise classifying the pressure change rate distribution and minimum error using a linear classifier; and indicating the leak in the fuel system based on an output of the linear classifier. The method may further comprise indicating an indeterminate result if the output of the linear classifier is within a threshold of a decision boundary. The technical result of implementing this method is an increased execution rate of an engine-off natural vacuum test. By indicating a leak based on a pressure change rate distribution rather than through simple thresholding, an engine-off natural vacuum test may be performed in a greater range of conditions. In this way, entry conditions for an engine-off natural vacuum test may be relaxed, while maintaining or improving the leak detection rate and reducing the misclassification rate.

A method for a fuel system comprises sealing a fuel system; and executing an evaporative emissions leak test only if a duration of a fuel system pressure increase event is greater than a threshold. Executing an evaporative emissions leak test may further comprise extracting one or more fuel system pressure features for classification via a linear classifier; and indicating a fuel system leak based on the extracted fuel system pressure features. The one or more fuel system pressure features may include a minimum error between a measured fuel tank pressure and a predicted fuel tank pressure. The measured fuel tank pressure may comprise an equilibrium fuel tank pressure. The predicted fuel tank pressure may be based on a fuel tank temperature. The predicted fuel tank pressure may be based on a fuel composition. The predicted fuel tank pressure may be determined using an Antoine equation relationship. The one or more fuel system pressure features may include a pressure change rate distribution within the fuel system during a condition where a pressure change rate is within a threshold of zero. The pressure change rate distribution may be filtered using a low-pass filter prior to classification by the linear classifier. In some examples, the method may further comprise comparing an output of the linear classifier to a decision boundary; and indicating an indeterminate result if the output of the linear classifier is within a threshold of a decision boundary. The technical result of implementing this method is a reduction in engine-off natural vacuum test duration. By, extracting fuel system features for classification by a linear classifier the EONV test may provide enough extractable features to classify a fuel system as intact or leaky without running the test to a vacuum threshold endpoint. This, in turn may reduce the amount of battery power used in performing the test.

In yet another example, a fuel system for a vehicle, comprising a fuel tank coupled to an evaporative emissions system; a valve coupled between the fuel tank and atmosphere; a pressure sensor coupled between the fuel tank and the valve; and a controller holding executable instructions in non-transitory memory, that when executed, cause the controller to: close the valve; execute an evaporative emissions leak test responsive to a duration of a fuel system pressure increase event being greater than a threshold; determine a minimum error between an equilibrium fuel tank pressure and a predicted fuel tank pressure; determine a pressure change rate distribution within the fuel system during a condition where a pressure change rate is within a threshold of zero; using a linear classifier, indicate a fuel system leak based on the determined minimum error and the determined pressure change rate distribution; and indicate an indeterminate result if an output of the linear classifier is within a threshold of a decision boundary. The technical result of implementing this system is an increase in the robustness of an engine-off natural vacuum test. By evaluating the initial fuel system pressure increase event, the misclassification rate of an engine-off natural vacuum test may be reduced. In this way, false results can be avoided, saving unnecessary warranty inspections and reducing overall costs for the vehicle manufacturer.

Note that the example control and estimation routines included herein can be used with various engine and/or vehicle system configurations. The control methods and routines disclosed herein may be stored as executable instructions in non-transitory memory. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for a fuel system, comprising:
indicating a leak in the fuel system based on a pressure change rate distribution during a first condition including a sealed fuel system and a pressure change rate within a threshold of zero.

2. The method of claim 1, further comprising:
applying a low-pass filter to the pressure change rate distribution; and then
indicating the leak in the fuel system based on the filtered pressure change rate distribution.

3. The method of claim 1, further comprising:
indicating the leak in the fuel system based on a minimum error between a measured fuel tank pressure and a predicted fuel tank pressure.

4. The method of claim 3, where the measured fuel tank pressure comprises an equilibrium fuel tank pressure.

5. The method of claim 3, where the predicted fuel tank pressure is based on a fuel tank temperature.

6. The method of claim 5, where the predicted fuel tank pressure is based on a fuel composition.

7. The method of claim 6, where the predicted fuel tank pressure is determined using an Antoine equation relationship.

8. The method of claim 3, further comprising:
classifying the pressure change rate distribution and minimum error using a linear classifier; and
indicating the leak in the fuel system based on an output of the linear classifier.

9. The method of claim 8, further comprising:
indicating an indeterminate result if the output of the linear classifier is within a threshold of a decision boundary.

10. A method for a fuel system, comprising:
sealing a fuel system; and
executing an evaporative emissions leak test only if a duration of a fuel system pressure increase event is greater than a threshold.

11. The method of claim 10, where executing an evaporative emissions leak test further comprises:
extracting one or more fuel system pressure features for classification via a linear classifier; and
indicating a fuel system leak based on the extracted fuel system pressure features.

12. The method of claim 11, where the one or more fuel system pressure features include a minimum error between a measured fuel tank pressure and a predicted fuel tank pressure.

13. The method of claim 12, where the measured fuel tank pressure comprises an equilibrium fuel tank pressure.

14. The method of claim 12, where the predicted fuel tank pressure is based on a fuel tank temperature.

15. The method of claim 14, where the predicted fuel tank pressure is based on a fuel composition.

16. The method of claim 15, where the predicted fuel tank pressure is determined using an Antoine equation relationship.

17. The method of claim 11, where the one or more fuel system pressure features include a pressure change rate distribution within the fuel system during a condition where a pressure change rate is within a threshold of zero.

18. The method of claim 17, where the pressure change rate distribution is filtered using a low-pass filter prior to classification by the linear classifier.

19. The method of claim 11, further comprising:
comparing an output of the linear classifier to a decision boundary; and
indicating an indeterminate result if the output of the linear classifier is within a threshold of a decision boundary.

20. A fuel system for a vehicle, comprising:
a fuel tank coupled to an evaporative emissions system;
a valve coupled between the fuel tank and atmosphere;
a pressure sensor coupled between the fuel tank and the valve; and
a controller holding executable instructions in non-transitory memory, that when executed, cause the controller to:
close the valve;
execute an evaporative emissions leak test responsive to a duration of a fuel system pressure increase event being greater than a threshold;
determine a minimum error between an equilibrium fuel tank pressure and a predicted fuel tank pressure;
determine a pressure change rate distribution within the fuel system during a condition where a pressure change rate is within a threshold of zero;
using a linear classifier, indicate a fuel system leak based on the determined minimum error and the determined pressure change rate distribution; and
indicate an indeterminate result if an output of the linear classifier is within a threshold of a decision boundary.
